(19) United States
(12) Patent Application Publication
(10) Pub. No.: US 2017/0078942 A1
(43) Pub. Date: Mar. 16, 2017

(54) METHOD AND NETWORK NODE FOR ROUTING IP PACKETS

(71) Applicant: TELEFONAKTIEBOLAGET LM ERICSSON (PUBL), Stockholm (SE)

(72) Inventors: Rui Fan, Beijing (CN); Hai Wang, Beijing (CN); Zhiheng Guo, Beijing (CN)

(21) Appl. No.: 15/309,270

(22) PCT Filed: May 9, 2014
(86) PCT No.: PCT/CN2014/077120

§ 371 Date: Nov. 7, 2016

(51) Int. Cl. H04W 40/02; H04L 12/46; H04L 29/12

(52) U.S. Cl. CPC H04W 40/02; H04L 61/2076; H04L 45/741; H04L 61/103; H04L 61/2015; H04L 12/4633; H04L 2212/00

(57) ABSTRACT

The disclosure provides a method in a network node for routing Internet Protocol (IP) packets. The method comprises: receiving from a Radio Access Network (RAN) node an IP address assignment request originated from a pico-Base Station (pico-BS) for assigning an IP address to the pico-BS. The RAN node is communicative with a backhaul User Equipment (UE) to which the pico-BS is connected. The method further comprises: assigning an IP address to the pico-BS in response to the IP address assignment request; encapsulating, upon receiving from another network node an IP packet destined to the IP address assigned to the pico-BS, the IP packet into a General Packet Radio Service (GPRS) Tunnel Protocol (GTP) packet; and transmitting the GTP packet to the RAN node.

### TECHNICAL FIELD

The disclosure relates to communication technology, and more particularly, to a method and network node for routing Internet Protocol (IP) packets to/from a pico-Base Station (pico-BS).

### BACKGROUND

With the evolution of wireless communication systems, there is an increasing demand for higher capacity and higher data transmission rate. Currently, a solution to satisfy this demand is to deploy pico cells. However, in many cases it is a difficult to establish a backhaul link between a pico-Base Station (pico-BS) and its associated core network by paving an optical fiber or providing a Line of Sight (LOS) radio link between them. Moreover, since there are different wireless communication systems with different radio access technologies co-existing in the market, such as Global System for Mobile Communication (GSM), Wideband Code Division Multiple Access (WCDMA) and Long Term Evolution (LTE), it is very expensive to establish dedicated backhaul links for each of these systems.

Therefore, an LTE-based non-LOS wireless backhaul solution has attracted more and more attention from telecommunication operators. According to this solution, a backhaul User Equipment (UE) and a backhaul evolved NodeB (eNB) are introduced for establishing a wireless backhaul link. A backhaul UE is an LTE terminal connected with a pico-BS via a wired connection (e.g., Ethernet connection). The backhaul UE receives backhaul packets (e.g., IP packets) from the pico-BS and forwards them to a backhaul eNB via a radio link. The backhaul eNB then forwards the backhaul packets to a core network node. On the other hand, IP packets destined to the pico-BS are received by the backhaul eNB and forwarded to the backhaul UE and then to the pico-BS.

However, in the above wireless backhaul solution, assignment of IP addresses to the pico-BS becomes problematic. Conventionally, the pico-BS can only use the same IP address as that assigned to the backhaul UE. In an IPv4-based LTE network, only one IP address can be assigned to the backhaul UE and thus only one IP address can be used by the pico-BS. However, the pico-BS typically requires more than one IP address. For example, the pico-BS may need one IP address for traffic and another IP address for Operation & Management (O&M). This problem will become even more severe when the pico-BS supports more than one wireless communication system, such as GSM, WCDMA and LTE.

Some solutions to this problem have been proposed. For example, if the backhaul

UE is attached to more than one Packet Data Network (PDN), each PDN can assign an IP address to the backhaul UE. In this case, the pico-BS can use the IP addresses assigned to the backhaul UE. In this solution, the backhaul UE has to setup more than one PDN connection over different Evolved Packet System (EPS) bearers. However, the number of EPS bearers that can be supported by the backhaul UE is limited. Meanwhile, it is inconvenient for the backhaul UE to setup multiple PDN connections.

As another solution, the Network Address Translation (NAT) technique can be adopted at the backhaul UE. With the NAT technique, the pico-BS can use multiple private IP addresses that share one single external IP address assigned to the backhaul UE. However, NAT is not transparent in IP forwarding. Moreover, in the NAT technique, different IP addresses are distinguished from each other based on port numbers. However, some packets in the LTE system have specified port numbers, for which the NAT technique is not applicable.

For an IPv6-based LTE network, a network prefix can be assigned to the backhaul UE. In this case, a number of IP addresses become available to the pico-BS. However, IPv6 is far from popular at present. Many operators' networks are still IPv4-based.

Therefore, there is a need for an improved solution for assigning IP addresses to a pico-BS and routing IP packets to/from the pico-BS efficiently.

### SUMMARY

It is an object of the disclosure to provide a method and a network node, as well as associated computer program and computer program product, capable of assigning IP addresses to a pico-BS and routing IP packets to/from the pico-BS efficiently.

According to a first aspect of the disclosure, a method in a network node for routing Internet Protocol (IP) packets is provided. The method comprises: receiving from a Radio Access Network (RAN) node an IP address assignment request originated from a pico-Base Station (pico-BS) for assigning an IP address to the pico-BS. The RAN node is communicative with a backhaul User Equipment (UE) to which the pico-BS is connected. The method further comprises: assigning an IP address to the pico-BS in response to the IP address assignment request; encapsulating, upon receiving from another network node an IP packet destined to the IP address assigned to the pico-BS, the IP packet into a General Packet Radio Service (GPRS) Tunnel Protocol (GTP) packet; and transmitting the GTP packet to the RAN node.

In an embodiment, the method further comprises: receiving from the other network node an Address Resolution Protocol (ARP) request associated with the IP address assigned to the pico-BS; and transmitting to the other network node an ARP response containing a hardware address of the network node as a hardware address corresponding to the pico-BS.

In an embodiment, the IP address assignment request is a Dynamic Host Configuration Protocol (DHCP) request and the network node and the backhaul UE act as a DHCP server and a DHCP proxy, respectively.

In an embodiment, the method further comprises: determining, upon receiving from the RAN node a GTP packet, that the GTP packet is associated with the backhaul UE based on a GTP Tunnel Identifier (TEID) contained in the GTP packet; decapsulating the GTP packet to obtain an IP packet contained in the GTP packet; routing the IP packet based on a destination IP address of the IP packet.

In an embodiment, the RAN node is an evolved NodeB (eNB) and the network node is located between the eNB and a core network.

According to a second aspect of the disclosure, a network node is provided. The network node comprises a transceiver, a processor and a memory, said memory containing instructions executable by said processor whereby said network node is operative to: receive from a Radio Access Network (RAN) node an Internet Protocol (IP) address assignment request originated from a pico-Base Station (pico-BS) for assigning an IP address to the pico-BS, the RAN node being communicative with a backhaul User Equipment (UE) to which the pico-BS is connected; assign an IP address to the pico-BS in response to the IP address assignment request; encapsulate, upon receiving from another network node an IP packet destined to the IP address assigned to the pico-BS, the IP packet into a General Packet Radio Service (GPRS) Tunnel Protocol (GTP) packet; and transmit the GTP packet to the RAN node.

In an embodiment, said memory further contains instructions executable by said processor whereby said network node is operative to: receive from the other network node an Address Resolution Protocol (ARP) request associated with the IP address assigned to the pico-BS; and transmit to the other network node an ARP response containing a hardware address of the network node as a hardware address corresponding to the pico-BS.

In an embodiment, the IP address assignment request is a Dynamic Host Configuration Protocol (DHCP) request and the network node and the backhaul UE act as a DHCP server and a DHCP proxy, respectively.

In an embodiment, said memory further contains instructions executable by said processor whereby said network node is operative to: determine, upon receiving from the RAN node a GTP packet, that the GTP packet is associated with the backhaul UE based on a GTP Tunnel Identifier (TEID) contained in the GTP packet; decapsulate the GTP packet to obtain an IP packet contained in the GTP packet; route the IP packet based on a destination IP address of the IP packet.

In an embodiment, the RAN node is an evolved NodeB (eNB) and the network node is located between the eNB and a core network.

According to a third aspect of the disclosure, a computer program is provided. The computer program comprises computer readable instructions which, when run on a network node, cause the network node to: receive from a Radio Access Network (RAN) node an Internet Protocol (IP) address assignment request originated from a pico-Base Station (pico-BS) for assigning an IP address to the pico-BS, the RAN node being communicative with a backhaul User Equipment (UE) to which the pico-BS is connected; assign an IP address to the pico-BS in response to the IP address assignment request; encapsulate, upon receiving from another network node an IP packet destined to the IP address assigned to the pico-BS, the IP packet into a General Packet Radio Service (GPRS) Tunnel Protocol (GTP) packet; and transmit the GTP packet to the RAN node.

According to a fourth aspect of the disclosure, a computer program product is provided. The computer program product comprises computer readable storage means storing the computer program according to the above third aspect.

With the embodiments of the disclosure, the network node can assign one or more IP addresses to the pico-BS at the request of the pico-BS. Then, upon receiving an IP packet destined to the IP address assigned to the pico-BS, the network node can encapsulate the IP packet into a GTP packet and transmit it to the RAN node such that the IP packet can be eventually received by the pico-BS.

Further, upon receiving a GTP packet containing an IP packet originated from the pico-BS, the network node determines that the GTP packet is associated with the backhaul UE and thus routes the IP packet based on its destination IP address. In this way, it is possible to assign more than one IP address to the pico-BS and route IP packets to/from the pico-BS efficiently.

### BRIEF DESCRIPTION OF THE DRAWINGS

The above and other objects, features and advantages will be more apparent from the following description of embodiments with reference to the figures, in which:

FIG. 1 is a flowchart illustrating a method in a network node for routing IP packets according to an embodiment of the disclosure;

FIG. 2 is a sequence chart explaining a process for routing IP packets to a pico-BS;

FIG. 3 is a sequence chart explaining a process for routing IP packets from a pico-BS;

FIG. 4 is a schematic diagram of a network node according to an embodiment of the disclosure; and

FIG. 5 is a schematic diagram of an arrangement that can be used in the network node according to an embodiment of the disclosure.

### DETAILED DESCRIPTION

The embodiments of the disclosure will be detailed below with reference to the drawings. It should be noted that the following embodiments are illustrative only, rather than limiting the scope of the disclosure.

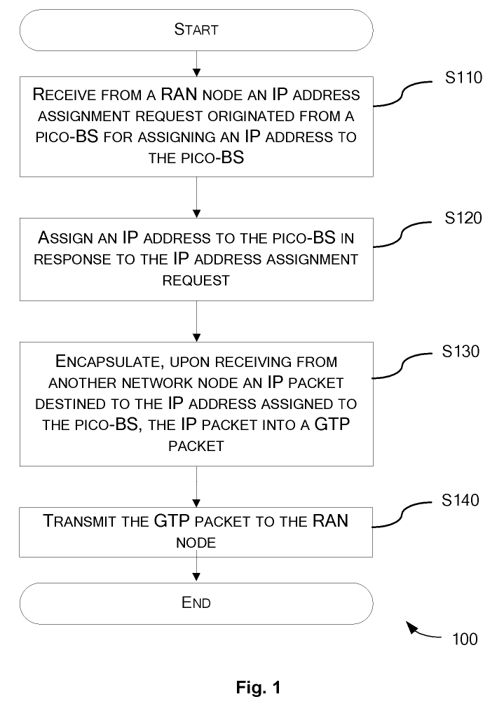

FIG. 1 is a flowchart illustrating a method 100 in a network node for routing IP packets according to an embodiment of the disclosure. Here the network node can be a proxy located between a Radio Access Network (RAN) node, which can be e.g., an enhanced NodeB (eNB), and a core network. The method 100 includes the steps as described below.

At step S110, an IP address assignment request is received from the RAN node. The request is originated from a pico-Base Station (pico-BS) and requests for assigning an IP address to the pico-BS. The RAN node is communicative with a backhaul UE to which the pico-BS is connected.

At step S120, an IP address is assigned to the pico-BS in response to the IP address assignment request. The IP address can be an IP address available in the IP subnet in which the network node resides.

As an example, the IP address assignment request in the step S110 can be a Dynamic Host Configuration Protocol (DHCP) request. In this case, the network node and the backhaul UE act as a DHCP server and a DHCP proxy, respectively, for assigning an IP address to the pico-BS in accordance with the DHCP protocol.

Alternatively, the IP address assigned to the pico-BS in the step S120 can be a manually specified IP address.

At step S130, when an IP packet destined to the IP address assigned to the pico-BS is received from another network node (referred to as “communication node” hereinafter), the IP packet is encapsulated into a General Packet Radio Service (GPRS) Tunnel Protocol (GTP) packet.

In an embodiment, before the IP packet can be received in the step S130, an Address Resolution Protocol (ARP) request associated with the IP address assigned to the pico-BS is received from the communication node. An ARP response containing a hardware address of the network node as a hardware address corresponding to the pico-BS is transmitted to the communication node.

At step S140, the GTP packet is transmitted to the RAN node. The GTP packet can be decapsulated at the RAN node to obtain the IP packet, which is then forwarded to the backhaul UE and finally to the pico-BS.

On the other hand, when a GTP packet is received from the RAN node, it is determined whether the GTP packet is associated with the backhaul UE based on a GTP Tunnel Identifier (TEID) contained in the GTP packet. When it is determined that the GTP packet is associated with the backhaul UE, the GTP packet is decapsulated to obtain an IP packet contained in the GTP packet. Then, the IP packet is routed based on a destination IP address of the IP packet. The determination as to whether the GTP packet is associated with the backhaul UE will be described later in connection with FIG. 3.

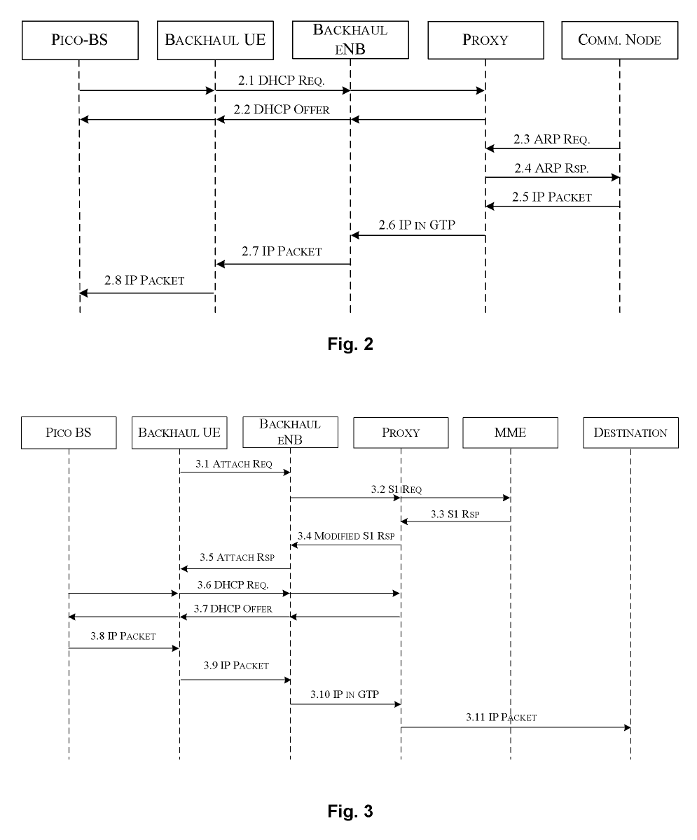

Now the method 100 will be explained in further detail with reference to the sequence chart of FIG. 2.

At 2.1, the network node (hereinafter referred to as “proxy”) receives from the RAN node (hereinafter referred to as “backhaul eNB”) a DHCP request message originated from the pico-BS. Here, the backhaul eNB is communicative with the backhaul UE to which the pico-BS is connected. At 2.2, the proxy sends a DHCP offer message to the backhaul eNB for assigning an IP address to the pico-BS. The DHCP offer message is forwarded to the backhaul UE and then to the pico-BS.

At 2.3, the communication node, which has an IP packet to be transmitted to the pico-BS, sends to the proxy an ARP request message associated with the IP address of the pico-BS (i.e., the IP address assigned to the pico-BS at 2.2). At 2.4, upon receiving the ARP request message, the proxy sends to the communication not an ARP response message containing a hardware address (e.g., a Media

Access Control (MAC) address) of the network node as a hardware address corresponding to the pico-BS. At 2.5, as the result of the ARP process, the communication node sends the IP packet to the proxy. At 2.6, the proxy encapsulates the IP packet into a GTP packet and sends it to the backhaul eNB.

At 2.7, the backhaul eNB decapsulates the GTP packet to obtain the IP packet and sends it to the backhaul UE. Finally at 2.8, the backhaul UE forwards the IP packet to the pico-BS.

Reference is now made to FIG. 3, which is a sequence chart explaining a process for routing IP packets from a pico-BS.

At 3.1, the backhaul UE sends an attach request to the backhaul eNB. The attach request is a NAS message destined to a core network node (a Mobility Management Entity (MME) in this example) and contains an identifier associated with the UE (also referred to as UE ID hereinafter). Here the identifier can be for example an IMSI number.

At 3.2, upon receiving the attach request, the backhaul eNB forwards the attach request to the proxy via an S1 interface. In particular, the backhaul eNB encapsulates the NAS message into an S1 request message for transmission to the proxy. Here, another identifier is allocated for the UE at the backhaul eNB, known as eNB UE S1 Application Protocol (S1AP) ID (also referred to as S1AP ID hereinafter). The S1AP ID is included in the S1 request message. Then, the proxy simply forwards the S1 request message to the MME.

At 3.3, upon receiving the S1 request message, the MME extracts the UE ID from the message and determines whether the UE is a backhaul UE or not based on the extracted UE ID. For example, the MME can maintain a list of UE IDs associated with backhaul UEs and can determine the UE to be a backhaul UE if the UE ID is found in the list. In this example, the MME determines that the UE is a backhaul UE and sends to the proxy an S1 response message (e.g., an initialContextSetupRequest message) containing an attach response destined to the UE. As an example, the S1 response message contains a predetermined GW IP address for indicating to the eNB that the UE is a backhaul UE. Here, the predetermined GW IP address can be a special, reserved IP address, such as 127.0.0.1, that does not present an address of a GW in the core network, but only notifies the eNB that the UE is a backhaul UE. The S1 response message also contains the S1AP ID associated with the UE.

At 3.4, upon receiving the S1 response message, the proxy determines from the predetermined GW IP address that the UE is a backhaul UE. The proxy modifies the S1 response message by setting a gateway IP address in the S1 response message to an IP address of the proxy itself and sends the modified S1 response message to the backhaul eNB. Also, the proxy obtains the S1AP ID associated with the UE from the S1 response message and allocates a unique GTP Tunnel Identifier (TEID) for the S1AP ID.

At 3.5, the eNB simply follows the traditional procedure, i.e., storing the GW IP address contained in the S1 response message (which is now in fact the IP address of the proxy) in its routing table. Additionally, the eNB extracts the attach response from the S1 response message and sends the attach response to the UE.

At 3.6, the proxy receives from the backhaul eNB a DHCP request message originated from the pico-BS. At 3.7, the proxy sends a DHCP offer message to the backhaul eNB for assigning an IP address to the pico-BS. The DHCP offer message is forwarded to the backhaul UE and then to the pico-BS.

At 3.8, the pico-BS sends an IP packet to the backhaul UE, which then forwards the packet to the backhaul eNB at 3.9.

At 3.10, upon receiving the IP packet, the backhaul eNB follows the traditional procedure, i.e., encapsulating the IP packet into a GTP packet and sending it to the GW IP address stored at 3.5 (i.e., the IP address of the proxy).

At 3.11, upon receiving the GTP packet, the proxy determines that the GTP packet is associated with the UE. In particular, the proxy can check whether the GTP TEID contained in the GTP packet matches the GTP TEID allocated at 3.4. If so, the proxy can determine that the GTP packet is associated with the UE. Then, the proxy decapsulates the GTP packet to obtain the IP packet contained in the GTP packet. Since the proxy is aware that the UE is a backhaul UE, the proxy can determine that the IP packet from the backhaul UE is a backhaul IP packet. Hence, the proxy routes the IP packet based on a destination IP address of the IP packet. That is, the proxy routes the IP packet to its destination directly, without sending it to a GW in the core network (which is so-called “local breakout”).

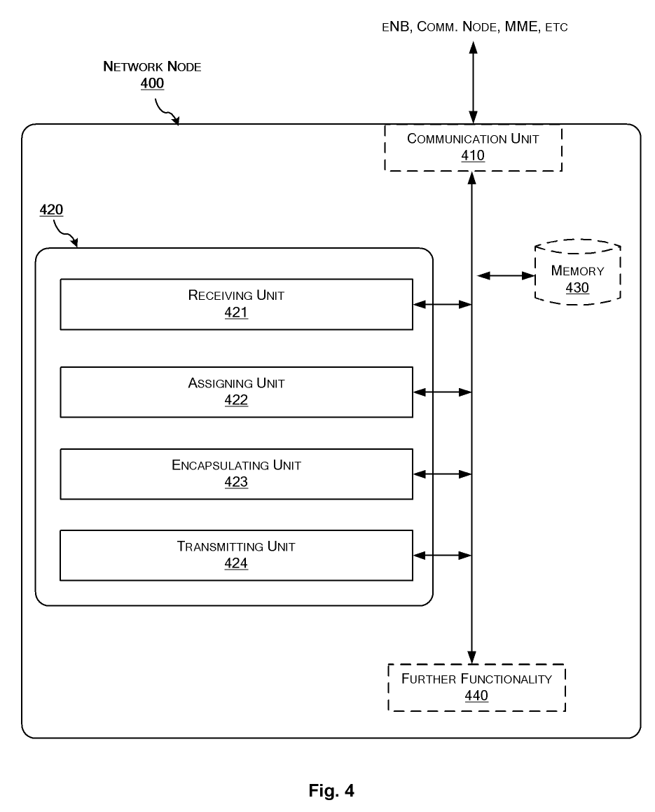

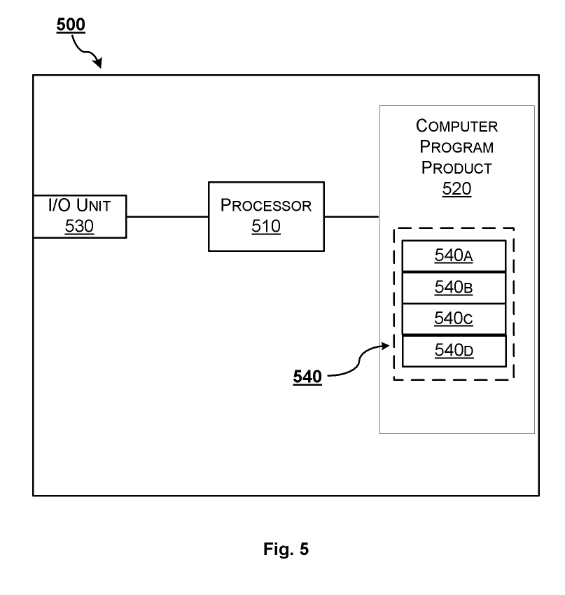

FIG. 4 is a schematic diagram of a network node 400 according to an embodiment of the disclosure.

As shown in FIG. 4, the network node 400 includes a communication unit 410 for communicating with other entities such as an eNB, a communication node and an

MME. The network node 400 further includes an arrangement 420 for implementing the method described above with reference to FIG. 1. The network node 400 may further comprise one or more memories 430 and one or more further functional units 440, such as functional units providing DHCP and ARP functions.

The arrangement 420 can be implemented, e.g., by one or more of: a processor or a micro processor and adequate software and memory for storing of the software, a Programmable Logic Device (PLD) or other electronic component(s) or processing circuitry configured to perform the actions described above, and illustrated, e.g., in FIG. 1. The arrangement 420 may be implemented and/or described as follows.

Referring to FIG. 4, the network node 400 includes a receiving unit 421 that receives from a RAN node an IP address assignment request originated from a pico-BS for assigning an IP address to the pico-BS. The RAN node is communicative with a backhaul UE to which the pico-BS is connected.

The network node 400 further includes an assigning unit 422 that assigns an IP address to the pico-BS in response to the IP address assignment request.

The network node 400 further includes an encapsulating unit 423 that encapsulates, upon receiving from another network node an IP packet destined to the IP address assigned to the pico-BS, the IP packet into a GTP packet.

The network node 400 further includes a transmitting unit 424 that transmits the GTP packet to the RAN node.

In an embodiment, the receiving unit 421 is further configured to receive from the other network node an ARP request associated with the IP address assigned to the pico-BS. The transmitting unit 424 is further configured to transmit to the other network node an ARP response containing a hardware address of the network node as a hardware address corresponding to the pico-BS.

In an embodiment, the IP address assignment request is a DHCP request and the network node and the backhaul UE act as a DHCP server and a DHCP proxy, respectively.

In an embodiment, the network node 400 further includes: a determining unit (not shown) that determines, upon receiving from the RAN node a GTP packet, that the GTP packet is associated with the backhaul UE based on a TEID contained in the GTP packet; a decapsulating unit (not shown) that decapsulates the GTP packet to obtain an IP packet contained in the GTP packet; and a routing unit (not shown) that routes the IP packet based on a destination IP address of the IP packet.

In an embodiment, the RAN node is an NB and the network node is located between the eNB and a core network.

FIG. 5 shows an embodiment of an arrangement 500 which may be used in the network node 400. The arrangement 500 includes a processor 510, e.g., a Digital Signal Processor (DSP). The processor 510 may be a single unit or a plurality of units to perform different actions of procedures described herein. The arrangement 500 may also comprise an input/output unit 530 for receiving/sending signal from/to other entities.

Furthermore, the arrangement 500 includes at least one computer program product 520 in the form of a non-volatile or volatile memory, e.g., an Electrically Erasable Programmable Read-Only Memory (EEPROM), a flash memory and a hard drive. The computer program product 520 includes a computer program 540.

The computer program 540 includes: code/computer readable instructions, which when executed by the processor 510 in the arrangement 500 causes the arrangement 500 and/or the network node 500 in which it is included to perform the actions, e.g., of the procedure described earlier in conjunction with FIG. 1.

The computer program product 540 may be configured as a computer program code structured in computer program modules 540A-540D.

Hence, in an exemplifying embodiment when the arrangement 500 is used in the network node 400, the code in the computer program of the arrangement 500 includes a receiving module 540A for receiving from a RAN node an IP address assignment request originated from a pico-BS for assigning an IP address to the pico-BS. The RAN node is communicative with a backhaul UE to which the pico-BS is connected. The code in the computer program of the arrangement 500 further includes an assigning module 540B for assigning an IP address to the pico-BS in response to the IP address assignment request. The code in the computer program of the arrangement 500 further includes an encapsulating module 540C for encapsulating, upon receiving from another network node an IP packet destined to the IP address assigned to the pico-BS, the IP packet into a GTP packet. The code in the computer program of the arrangement 500 further includes a transmitting module 540D for transmitting the GTP packet to the RAN node

The computer program modules could essentially perform the actions of the flow illustrated in FIG. 1, to emulate the arrangement 420 in the network node 400. In other words, when the different computer program modules are executed in the processor 510, they may correspond, e.g., to the units 421-424 of FIG. 4.

Although the code means in the embodiments disclosed above in conjunction with FIG. 5 are implemented as computer program modules which when executed in the processing unit causes the device to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1. A method in a network node for routing Internet Protocol (IP) packets, comprising:
receiving from a Radio Access Network (RAN) node an IP address assignment request originated from a pico-Base Station (pico-BS) for assigning an IP address to the pico-BS, the RAN node being communicative with a backhaul User Equipment (UE) to which the pico-BS is connected;
assigning an IP address to the pico-BS in response to the IP address assignment request;
encapsulating, upon receiving from another network node an IP packet destined to the IP address assigned to the pico-BS, the IP packet into a General Packet Radio Service (GPRS) Tunnel Protocol (GTP) packet; and
transmitting the GTP packet to the RAN node.

2. The method of claim 1, further comprising:
receiving from the other network node an Address Resolution Protocol (ARP) request associated with the IP address assigned to the pico-BS; and
transmitting to the other network node an ARP response containing a hardware address of the network node as a hardware address corresponding to the pico-BS.

3. The method of claim 1, wherein the IP address assignment request is a Dynamic Host Configuration Protocol (DHCP) request and the network node and the backhaul UE act as a DHCP server and a DHCP proxy, respectively.

4. The method of claim 1, further comprising:
determining, upon receiving from the RAN node a GTP packet, that the GTP packet is associated with the backhaul UE based on a GTP Tunnel Identifier (TEID) contained in the GTP packet;
decapsulating the GTP packet to obtain an IP packet contained in the GTP packet;
routing the IP packet based on a destination IP address of the IP packet.

5. The method of claim 1, wherein the RAN node is an evolved NodeB (eNB) and the network node is located between the eNB and a core network.

6. A network node comprising a transceiver, a processor and a memory, said memory containing instructions executable by said processor whereby said network node is operative to:
receive from a Radio Access Network (RAN) node an Internet Protocol (IP) address assignment request originated from a pico-Base Station (pico-BS) for assigning an IP address to the pico-BS, the RAN node being communicative with a backhaul User Equipment (UE) to which the pico-BS is connected;
assign an IP address to the pico-BS in response to the IP address assignment request;
encapsulate, upon receiving from another network node an IP packet destined to the IP address assigned to the pico-BS, the IP packet into a General Packet Radio Service (GPRS) Tunnel Protocol (GTP) packet; and
transmit the GTP packet to the RAN node.

7. The network node of claim 6, said memory further contains instructions executable by said processor whereby said network node is operative to:
receive from the other network node an Address Resolution Protocol (ARP) request associated with the IP address assigned to the pico-BS; and
transmit to the other network node an ARP response containing a hardware address of the network node as a hardware address corresponding to the pico-BS.

8. The network node of claim 6, wherein the IP address assignment request is a Dynamic Host Configuration Protocol (DHCP) request and the network node and the backhaul UE act as a DHCP server and a DHCP proxy, respectively.

9. The network node of claim 6, said memory further contains instructions executable by said processor whereby said network node is operative to:
determine, upon receiving from the RAN node a GTP packet, that the GTP packet is associated with the backhaul UE based on a GTP Tunnel Identifier (TEID) contained in the GTP packet;
decapsulate the GTP packet to obtain an IP packet contained in the GTP packet;
route the IP packet based on a destination IP address of the IP packet.

10. The network node of claim 6, wherein the RAN node is an evolved NodeB (eNB) and the network node is located between the eNB and a core network.

11-12. (canceled)
